(19) United States
(12) Patent Application Publication
(10) Pub. No.: US 2025/0256485 A1
(43) Pub. Date: Aug. 14, 2025

(54) Bitumen-Based Laminate Having a Biodegradable Liner

(71) Applicant: Berry Global, Inc., Evansville, IN (US)

(72) Inventors: Miriam Malocho, MÖNCHENGLADBACH (DE); Sonia Isabelle Sandra Vukmirovic, Lambersart (FR)

(21) Appl. No.: 19/054,561

(22) Filed: Feb. 14, 2025

Related U.S. Application Data
(60) Provisional application No. 63/553,339, filed on Feb. 14, 2024.

(51) Int. Cl. B32B 11/10; B32B 5/02; B32B 23/00; B32B 37/18

(52) U.S. Cl. CPC B32B 11/10; B32B 5/022; B32B 23/00; B32B 37/18; B32B 2250/02; B32B 2262/062; B32B 2305/22; B32B 2307/54; B32B 2307/7163; B32B 2307/724; B32B 2307/7376; B32B 2317/18; B32B 2395/00; B32B 2419/06

(57) ABSTRACT

Laminates including (i) a bitumen-containing sheet (BCS) having a first side surface and a second side surface, and (ii) a biodegradable nonwoven liner (BNL) laminated to the first side surface of the BCS are provided. The BNL comprises a plurality of regenerated cellulose fibers, in which the plurality of regenerated cellulose fibers are inherently hydrophobic and/or rendered hydrophobic via a topically applied hydrophobic additive.

### CROSS-REFERENCE TO RELATED APPLICATIONS

This application claims priority under 35 U.S.C. § 119(e) to U.S. Provisional Application No. 63/553,339, filed Feb. 14, 2024, which is expressly incorporated by reference herein in its entirety.

### TECHNICAL FIELD

Embodiments of the presently-disclosed invention relate generally to laminates, such as a bitumen-based roofing material, including a bitumen-containing sheet (BCS) and a biodegradable nonwoven liner (BNL) laminated to the BCS, in which the BNL includes a plurality of hydrophobic regenerated cellulose fibers.

### BACKGROUND

In the construction industry, it is customary to provide a structure with an outer layer of protection against the ingress of liquid water. Most commonly these layers include brick or siding used on walls and metal, and metal, rubber, or bitumen based roofing systems used on roof decks. With regard to roof coverings and roofing underlayments, it is well known to use bituminous compositions for manufacturing waterproofing membranes or sheets. These bitumen-based sheets, for instance, may be provided to an end-user in the form of a roll of the roofing material (e.g., the bitumen-based sheet). Such rolled-roofing materials, for instance, may often include a liner to prevent self-adhesion of the bitumen material to adhere to itself while in a rolled state. Such liners, however, generally need to be removed and/or discarded upon or after application of the roofing material onto a construction surface (e.g., a roof). The removal and discarding of these liners can be onerous due to the non-biodegradable nature of the liners.

Accordingly, there remains a need in the art for a bitumen-based roofing laminate in which the hassle associated with removing the liner is averted, such as having a liner that can release itself over time and enter the nature (e.g., the external environment) without any concern as by then it will already have disintegrated into small pieces and full biodegradation process will eventually progress fast.

### SUMMARY OF INVENTION

One or more embodiments of the invention may address one or more of the aforementioned problems. Certain embodiments according to the invention provide laminates including (i) a bitumen-containing sheet (BCS) having a first side surface and a second side surface, and (ii) a biodegradable nonwoven liner (BNL) laminated to the first side surface of the BCS are provided. The BNL comprises a plurality of regenerated cellulose fibers, in which the plurality of regenerated cellulose fibers are inherently hydrophobic and/or rendered hydrophobic via a topically applied hydrophobic additive.

In another aspect, the present invention provides methods of forming a laminate, such as those described and disclosed herein. The methods of forming a laminate may include the following steps: (i) providing or forming a bitumen-containing sheet (BCS) having a first side surface and a second side surface; (ii) providing or forming a biodegradable nonwoven liner (BNL); wherein the plurality of regenerated cellulose fibers are inherently hydrophobic and/or rendered hydrophobic via a topically applied hydrophobic additive; and (iii) laminating the BNL to the first side surface of the BCS at an elevated temperature.

In another aspect, the present invention provides methods of covering a portion of a construction surface comprising the following steps: (i) providing a laminate, such as those described and disclosed herein; (ii) applying a portion of the laminate onto the construction surface, wherein the BCS is located proximate to the construction surface and the BNL is located distal to the construction surface; and (iii) adhering the BCS to the construction surface.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a laminate in accordance with certain embodiments of the invention; and

FIG. 2 illustrates another laminate in accordance with certain embodiments of the invention;

### DETAILED DESCRIPTION

The invention now will be described more fully hereinafter. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Certain embodiments of the invention may be directed to laminates, such as a bitumen-based roofing laminate having a biodegradable nonwoven liner (BNL). In accordance with certain embodiments of the invention, the BNL may have a temporary function as a support for the bitumen-containing sheet (BCS) to allow easy handling and installation of bitumen waterproof roof sheets. The BNL, for instance, may not and in some cases should not impart or otherwise impact the functional properties of the BCS, which includes a bitumen-containing composition (BSS). After installation the BNL generally has no further function, in accordance with certain embodiments of the invention, and with time it tends to slowly peel off and eventually enter the environment. The BNL may be formed entirely or at least in part by a plurality of hydrophobic regenerated cellulose fibers (e.g., viscose fibers). In this regard, the BCS and the BNL can be brought together to form a laminate construction, for example, during the hot extrusion process of the BCS. In accordance with certain embodiments of the invention, the BNL can withstand the hot process associated with extrusion of the BCS and adhere to the BCS without penetrating (or at least significantly) into the BCS or vice versa. The laminates may be formed and wound up on a collection roll to provide a rolled laminate that may be delivered to a work site for installation.

The term “machine direction” or “MD”, as used herein, comprises the direction in which the fabric produced or conveyed. The term “cross-direction” or “CD”, as used herein, comprises the direction of the fabric substantially perpendicular to the MD.

The terms “nonwoven” and “nonwoven web”, as used herein, may comprise a web having a structure of individual fibers, fibers, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process. In certain instances, the “nonwoven web” may comprises a plurality of layers, such as one or more spunbond layers and/or one or more meltblown layers. For instance, a “nonwoven web” may comprises a spunbond-meltblown-spunbond structure.

The terms “fabric” and “nonwoven fabric”, as used herein, may comprise a web of fibers in which a plurality of the fibers are mechanically entangled or interconnected, fused together, and/or chemically bonded together For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. In accordance with certain embodiments of the invention, any thermally fused together fiber portions or fusible fibers (e.g., polybutylene succinate (PBS), polylactic acid (PLA), Cellulose Acetate, etc.) may be biodegradable within the context of the present invention. In accordance with certain embodiments of the invention, chemical bonding may utilize a chemical bonding chemistry that is biodegradable within the context of the present invention. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Furthermore, the term “consolidated” and “consolidation” may comprise the bonding by means of a through-air-bonding operation. The term “through-air bonded” and “though-air-bonding”, as used herein, may comprise a nonwoven web consolidated by a bonding process in which hot air is used to fuse the fibers at the surface of the web and optionally internally within the web. By way of example only, hot air can either be blown through the web in a conveyorized oven or sucked through the web as it passes over a porous drum as a vacuum is developed. The temperature of and the rate of hot air are parameters that may determine the level or the extent of bonding in nonwoven web. In accordance with certain embodiments of the invention, the temperature of the hot air may be high enough to melt, induce flowing, and/or fuse the a plurality of fibers having a lower melting point temperature or onset of lower melting point temperature (e.g., amorphous fibers) to a plurality of fibers having a higher melting point temperature or onset of lower melting point temperature (e.g., semi-crystalline or crystalline fibers). Such a web may be considered a “consolidated nonwoven”, “nonwoven fabric” or simply as a “fabric” according to certain embodiments of the invention.

The term “regenerated cellulose” and “regenerated cellulose fibers”, as used herein, may refer to a class of materials manufactured by the conversion of natural cellulose to a soluble cellulosic derivative and subsequent regeneration. It may be obtained in a changed form by chemical treatment of a cellulose solution or derivative. Regenerated cellulose products, such as fibers, may result from the dissolution-regeneration process risen from solvent and anti-solvent reagents, respectively. Regenerated cellulose fibers may be made from cellulose-based materials that originate from organic material, such as plants (e.g., wood pulp). The classification of the particular regenerated cellulose fibers relate to the chemical solvent system used to extract the fiber, so regenerated fibers are part natural and part artificial. Regenerated cellulose fibers, for example, may include viscose fibers, rayon fibers, lyocell fibers, etc.).

The term “hydrophobic”, as used herein, may refer to a material (e.g., fibers, nonwoven web and/or fabric, etc.) having a surface that tends to not absorb water or be wetted by water. In this regard, a material or surface may be considered “hydrophobic” if water forms distinct droplets thereon, in which contact angles of water on the material or surface that are greater than 900 may be designated as hydrophobic.

As used herein, the term “continuous fibers” refers to fibers which are not cut from their original length prior to being formed into a nonwoven web or nonwoven fabric. Continuous fibers, such as spunbond, may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

The term “staple fiber”, as used herein, may comprise a cut fiber from a filament. In accordance with certain embodiments, any type of filament material may be used to form staple fibers. For example, staple fibers may be formed from regenerated cellulose, polymeric fibers, and/or elastomeric fibers. The average length of staple fibers may comprise, by way of example only, from about 2 centimeter to about 15 centimeter.

In one aspect, the present invention provides laminates including (i) a bitumen-containing sheet (BCS) having a first side surface and a second side surface, and (ii) a biodegradable nonwoven liner (BNL) laminated to the first side surface of the BCS are provided. The BNL comprises a plurality of regenerated cellulose fibers, in which the plurality of regenerated cellulose fibers are inherently hydrophobic and/or rendered hydrophobic via a topically applied hydrophobic additive. In accordance with certain embodiments of the invention, wherein the plurality of regenerated cellulose fibers may comprise viscose fibers, rayon fibers, acetate fibers, triacetate fibers, modal fibers, lyocell fibers, PBS fibers, or any combination thereof.

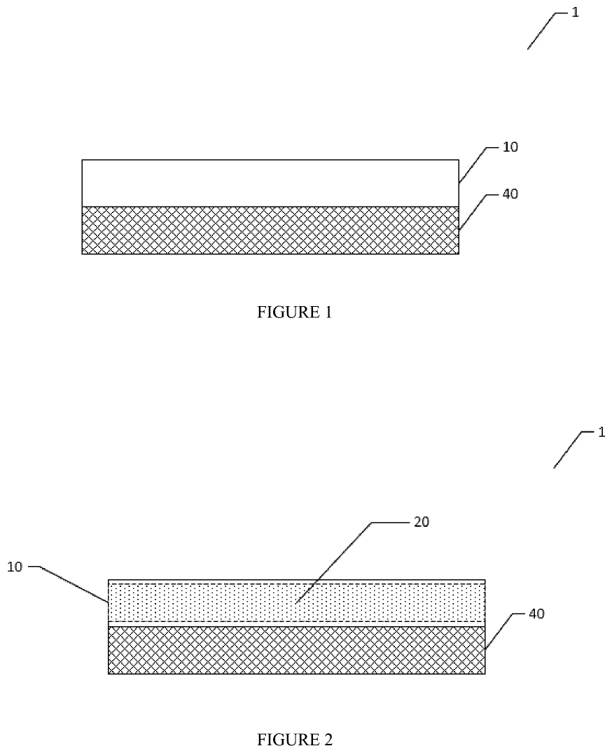

FIG. 1 illustrates a laminate 1, in accordance with certain embodiments of the invention, in which the laminate includes a BCS 10 and a BNL 40 laminated to the BCS. For instance, the BNL and the BCS may be adjacent and in direct contact with each other.

In accordance with certain embodiments of the invention, the plurality of regenerated cellulose fibers may comprise inherently hydrophobic viscose fibers, such as OLEA viscose fibers commercially available from Kelheim Fibers (Germany) and/or inherently hydrophobic lyocell fibers, such as VEOCELbrand's Lyocell Dry commercially available from Lenzing (Austria). Lycocell Dry fibers are hydrophobic cellulose fibers that is certified as being biodegradable and compostable under a variety of conditions and is derived from wood sources. Through the application of Alkyl Ketene Dimer (AKD, such as less than 0.1% by weight) on the fiber surface, the lyocell fibers are rendered hydrophobic. In order to retain the hydrophobic nature throughout the product life cycle, a small part of the AKD bonds to the cellulose polymer, resulting in a partially modified polymer structure. Accordingly, Lyocell Dry fibers consist of over 99% by weight of cellulose.

The plurality of regenerated cellulose fibers, for example, may be inherently hydrophobic viscose fibers having a cellulose matrix (e.g., regenerated cellulose matrix) and a hydrophobic substance incorporated into the cellulose matrix. As such, the hydrophobicity of the fibers may not be reduced, at least significantly, over time. For example, non-limiting hydrophobic substances may include alkyl ketene dimers, alkenyl ketene dimers, alkyl succinic anhydrides, alkenyl succinic anhydrides, alkyl glutaric acid anhydrides, alkenyl glutaric acid anhydrides, alkyl isocyanates, alkenyl isocyanates, fatty acid anhydrides, and any combination thereof. By way of example only, the inherently hydrophobic regenerated cellulose fibers (e.g., inherently hydrophobic viscose fibers) may include from about 0.1 to about 5% by weight of the hydrophobic substance, such as at least about any of the following: 0.1, 0.3, 0.5, 0.8, 1, 1.2, 1.5, 1.8, 2, 2.5, and 3% by weight, and/or at most about any of the following: 5, 4.8, 4.5, 4.2, 4, 3.8, 3.5, 3.2, and 3% by weight.

In accordance with certain embodiments of the invention, the BNL has a total fiber content and the plurality of regenerated cellulose fibers may comprise from about 20 to about 100% by weight of the total fiber content, such as at least about any of the following: 20, 25, 30 35, 40, and 45% by weight of the total fiber content, and/or at most about any of the following: 100, 95, 90, 85, 80, 75, 70, 65, 60, 55, 50, and 45% by weight of the total fiber content. In accordance with certain embodiments of the invention, any non-regenerated cellulose fibers may comprise polyolefin fibers, polyamide fibers, and/or polyester fibers, which may be continuous fibers (e.g., spunbond fibers) and/or staple fibers. Additionally or alternatively, the BNL may have a basis weight from about 15 to about 300 grams-per-square-meter (gsm), such as at least about any of the following: 15, 20, 25, 30, 35, 40, 45, 50, 55, 60, 70, 80, 90, 100, 120, and 150 gsm, and/or at most about any of the following: 300, 270, 250, 220, 200, 180, and 150 gsm.

The plurality of regenerated cellulose fibers, in accordance with certain embodiments, may comprise staple fibers. For instance, the staple fibers may have an average length from about 0.5 to about 15 cm, such as at least about any of the following: 0.5, 1, 2, 4, 6, 8, and 10 cm, and/or at most about any of the following: 15, 14, 12, and 1 cm. Additionally or alternatively, the staple fibers have an average titer from about 0.5 to about 30 decitex (dtex), such as at least about any of the following: 0.5, 0.8, 1, 1.3, 1.5, 1.7, 2, 3, 5, 8, and 10 dtex, and/or at most about any of the following: 30, 25, 20, 18, 15, 12, and 10 dtex. Additionally or alternatively, the plurality of regenerated cellulose fibers may comprise electrospun fibers and/or continuous fibers.

The plurality of regenerated cellulose fibers of the BNL may be consolidated via one or more modalities as described herein. In accordance with certain embodiments of the invention, the plurality of regenerated cellulose fibers may be mechanically entangled together, such as by needling and/or hydroentanglement. Additionally or alternatively, the BNL may also comprise thermal bond sites defining a thermal bond area, such as from about 2 to about 30%, such as at least about any of the following: 2, 3, 5, 8, 10, 12, 15, 18, and 20%, and/or at most about any of the following: 30, 28, 25, 22, and 20%.

In accordance with certain embodiments of the invention, the BNL may have an air permeability of from about 5 to about 80 cubic-feet-per-minute (CFM) as determined by IST 70.1, such as at least about any of the following: 5, 10, 15, 20, 25, 30, 35, and 40 CFM as determined by IST 70.1, and/or at most about any of the following: 100, 90, 80, 70, 60, 50, and 40 CFM as determined by IST 70.1. Additionally or alternatively, the BCS penetrates into the BNL in the z-direction by no more than about 10% of the thickness of the BNL, such as at least about any of the following: 0, 1, 2, 3, 4, and 5% of the thickness of the BNL, and/or at most about any of the following: 10, 9, 8, 7, 6, and % of the thickness of the BNL.

In accordance with certain embodiments of the invention, the BNL has a thickness in a z-direction that is perpendicular to a machine direction (MD) and a cross-direction (CD), wherein the thickness comprises from 0.1 to about 1.2 mm in a relaxed state, such as at least about any of the following: 0.1, 0.2, 0.3, 0.4, 0.5, 0.55, 0.6, 0.65, 0.7, and 0.75 mm in a relaxed state, and/or at most about any of the following: 1.2, 1.1, 1, 0.95, 0.9, 0.85, 0.8, and 0.75 mm in a relaxed state. Additionally or alternatively, the BNL has a machine-direction (MD) tensile strength from about 5 to about 25 pounds as determined per ASTM D5729, such as at least about any of the following: 5, 8, 10, 12, 14, 15, 16, 18, and 20 pounds as determined per ASTM D5729, and/or at most about any of the following: 25, 24, 22, and 20 pounds as determined per ASTM D5729. According to some TDS I have from Berry Benson ASTM D5729 is a TM (Test Method) for determining Thickness while ASTM D5034 for determining tensile strength and elongation! Additionally or alternatively, the BNL has a first ratio between the MD tensile strength (lbs) and a thickness (mm) of the nonwoven fabric in a related state from about 20 to about 40, such as at least about any of the following: 20, 22, 24, 25, 26, 28, and 30; and/or at most about any of the following: 40, 38, 36, 35, 24, 32, and 30. Additionally or alternatively, the BNL has a machine direction (MD) elongation at break from about 3 to about 30% as determined per ASTM D5729, such as at least about any of the following: 3, 4, 5, 6, 8, 10, 12, and 15% as determined per ASTM D5729, and/or at most about any of the following: 30, 28, 25, 2, 20, 18, and 15% as determined per ASTM D5729. Additionally or alternatively, the BNL has a second ratio between the MD elongation (%) and the thickness (mm) of the nonwoven fabric in a related state of at most about 20, such as at least about any of the following: 5, 6, 8, and 10; and/or at most about any of the following: 20, 18, 16, 15, 14, 12, and 10.

In accordance with certain embodiments of the invention, the BCS comprises a bitumen-containing composition (BCC) including an asphalt component and optionally combined with a polymerized rubber component and/or a polymerized plastic component. For example, the BCS may comprises an atactic polypropylene (APP) membrane, a styrene-butadiene-styrene (SBS) membrane, a styrene-isoprene-styrene (SIS) membrane, or any combination thereof. Additionally or alternatively, the BCS may comprise a reinforcement matt of fibers, and wherein the BCC is at least partially impregnated into the reinforcement matt of fibers. In accordance with certain embodiments of the invention, the reinforcement matt of fibers is saturated with the BCC. By way of example only, the reinforcement matt of fibers comprise fiberglass stale fibers. The reinforcement matt of fibers, for example, may be consolidated by an adhesive composition or mechanical consolidation.

FIG. 2 illustrates a laminate 1, in accordance with certain embodiments of the invention, including a BCS 10 directly laminated to a BNL 40, in which the BCS includes a reinforcement matt of fibers 20 encased and/or saturated with a BCC of the BCS.

In accordance with certain embodiments of the invention, the BCS may have a thickness from about 3 to about 15 mm, such as at least about any of the following: 3, 4, 5, 6, 8, and 10 mm, and/or at most about any of the following: 15, 14, 12, and 10 mm.

In accordance with certain embodiments of the invention, the laminate may optionally include a layer of adhesive deposited onto the second side surface of the BCS. Optionally a release liner may be positioned over the top of the layer of adhesive. The release liner may comprise a second BNL. The layer of adhesive may not be particularly limited, and may comprise a pressure-sensitive adhesive and/or heat-activated adhesive. Such embodiments of the invention, for example, may provide or define a self-adhering laminate (e.g., roofing laminate).

In another aspect, the present invention provides methods of forming a laminate, such as those described and disclosed herein. The methods of forming a laminate may include the following steps: (i) providing or forming a bitumen-containing sheet (BCS) having a first side surface and a second side surface; (ii) providing or forming a biodegradable nonwoven liner (BNL); wherein the plurality of regenerated cellulose fibers are inherently hydrophobic and/or rendered hydrophobic via a topically applied hydrophobic additive; and (iii) laminating the BNL to the first side surface of the BCS at an elevated temperature.

In accordance with certain embodiments of the invention, the elevated temperature is below a melting point or melting range of the plurality of regenerated cellulose fibers and sufficiently large to ensure the adherence of the BCS to the BNL. By way of example only, the elevated temperature may be from about 140 to about 165° C., such as at least about any of the following: 140, 145, and 150° C., and/or at most about any of the following: 160, 155, and 150° C.

In accordance with certain embodiments of the invention, the step of laminating the BCS and the BNL together is performed under an applied pressure. For example, the BCS and the BNL may be placed in direct contact with each other and passed through a nip defined by a pair of laminating rolls, in which the nip has a nip-gauge defined by a closest distance between the pair of laminating rolls. In this regard, the applied pressure may be controlled (e.g., increased or decreased) by selecting and/or adjusting the nip-gauge.

In accordance with certain embodiments of the invention, the method may further comprise a step of applying a layer of adhesive onto the second side surface of the BCS. The layer of adhesive may be continuous or dis-continuous and/or have a basis weight from 0.1 to about 10 gsm, such as at least about any of the following: 0.1, 0.5. 1, 3, and 5 gsm, and/or at most about any of the following: 10, 8, 6, and 5 gsm.

In another aspect, the present invention provides methods of covering a portion of a construction surface (e.g., a roof) comprising the following steps: (i) providing a laminate, such as those described and disclosed herein; (ii) applying a portion of the laminate onto the construction surface, wherein the BCS is located proximate to the construction surface and the BNL is located distal to the construction surface; and (iii) adhering the BCS to the construction surface.

The step of adhering the BCS to the construction surface may comprise torch welding the BCS to the construction surface by heating the BCS to at least soften the BCC to form a self-adhesive BCC, followed applying pressure onto the laminate towards the construction surface such that the self-adhesive BCC contacts the construction surface. Alternatively, the step of adhering the BCS to the construction surface may comprise applying an adhesive agent to the BCS and/or the construction surface, followed applying pressure onto the laminate towards the construction surface such that the adhesive agent bonds and is contact with the BCS and the construction surface. In this regard, the adhesive agent may be provided separately from the laminate and applied to the BCS and/or the construction surface at the time of installation of the laminate onto the construction surface. Additionally or alternatively, the laminate may be manufactured to include a layer of adhesive deposited onto the second side surface of the BCS, as noted above, and wherein adhering the BCS to the construction surface comprises positioning the layer of adhesive onto the construction surface and applying pressure onto the laminate towards the construction surface such that the layer of adhesive bonds and is contact with the BCS and the construction surface.

In accordance with certain embodiments of the invention, the laminate may be provided in the form of a roll having a first end and a second end, and wherein the first end of the roll is adhered to the construction surface, and the roll is unwound and adhered to the construction surface. In this regard, a plurality of laminates in rolled form may be applied to a construction surface, in which each roll is unwound such that adjacently laid laminates overlap by at least a portion to avoid gaps or seems between adjacent laminate that may fail to provide water protection to the construction surface.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A laminate, comprising:
(i) a bitumen-containing sheet (BCS) having a first side surface and a second side surface;
(ii) a biodegradable nonwoven liner (BNL) laminated to the first side surface of the BCS; wherein the BNL comprises a plurality of regenerated cellulose fibers; wherein the plurality of regenerated cellulose fibers are inherently hydrophobic and/or rendered hydrophobic via a topically applied hydrophobic additive.

2. The laminate of claim 1, wherein the BNL has a basis weight from about 20 to about 300 grams-per-square-meter (gsm).

3. The laminate of claim 1, wherein the plurality of regenerated cellulose fibers comprise viscose fibers, rayon fibers, acetate fibers, triacetate fibers, modal fibers, lyocell fibers, or any combination thereof.

4. The laminate of claim 3, wherein the plurality of regenerated cellulose fibers comprise inherently hydrophobic viscose fibers, such as OLEA viscose fibers commercially available from Kelheim Fibers or inherently hydrophobic lyocell fibers, such as VEOCEL from Lenzing.

5. The laminate of claim 3, wherein the plurality of regenerated cellulose fibers comprise inherently hydrophobic viscose fibers having a cellulose matrix and a hydrophobic substance incorporated into the cellulose matrix.

6. The laminate of claim 5, wherein the hydrophobic substance comprises alkyl ketene dimers, alkenyl ketene dimers, alkyl succinic anhydrides, alkenyl succinic anhydrides, alkyl glutaric acid anhydrides, alkenyl glutaric acid anhydrides, alkyl isocyanates, alkenyl isocyanates, fatty acid anhydrides, and any combination thereof.

7. The laminate of claim 5, wherein the inherently hydrophobic viscose fibers include from about 0.1 to about 5% by weight of the hydrophobic substance.

8. The laminate of claim 1, wherein the BNL has a total fiber content and the plurality of regenerated cellulose fibers comprise from about 20 to about 80% by weight of the total fiber content.

9. The laminate of claim 1, wherein the plurality of regenerated cellulose fibers comprise staple fibers.

10. The laminate of claim 9, wherein (i) the staple fibers have an average length from about 0.5 to about 15 cm; (ii) the staple fibers have an average titer from about 0.5 to about 30 decitex (dtex); or (iii) both (i) and (ii).

11. The laminate of claim 1, wherein the plurality of regenerated cellulose fibers of the BNL are mechanically entangled together.

12. The laminate of claim 11, wherein the BNL further comprises thermal bond sites defining a thermal bond area, such as from about 2 to about 30%.

13. The laminate of claim 1, wherein (i) the BNL has an air permeability of from about 5 to about 80 cubic-feet-per-minute (CFM) as determined by IST 70.1; (ii) the BNL has a thickness in a z-direction that is perpendicular to a machine direction (MD) and a cross-direction (CD), and wherein the thickness comprises from 0.5 to about 1.2 mm in a relaxed state; or (i) and (ii).

14. The laminate of claim 1, wherein (i) the BNL has a machine-direction (MD) tensile strength from about 5 to about 25 pounds as determined per ASTM D5729; (ii) the BNL has a first ratio between the MD tensile strength (lbs) and a thickness (mm) of the nonwoven fabric in a related state from about 20 to about 40; or both (i) and (ii).

15. The laminate of claim 1, wherein (i) the BNL has a machine direction (MD) elongation at break from about 3 to about 30% as determined per ASTM D5729; (ii) the BNL has a second ratio between the MD elongation (%) and the thickness (mm) of the nonwoven fabric in a related state of at most about 20; or both (i) and (ii).

16. A method of forming a laminate, comprising:
(i) providing or forming a bitumen-containing sheet (BCS) having a first side surface and a second side surface;
(ii) providing or forming a biodegradable nonwoven liner (BNL); wherein the plurality of regenerated cellulose fibers are inherently hydrophobic and/or rendered hydrophobic via a topically applied hydrophobic additive; and
(iii) laminating the BNL to the first side surface of the BCS at an elevated temperature.

17. The method of claim 16, wherein the elevated temperature is below a melting point or melting range of the plurality of regenerated cellulose fibers and sufficiently large to ensure the adherence of the BCS to the BNL.

18. The method of claim 17, further comprising applying a layer of adhesive onto the second side surface of the BCS.

19. A method of covering a portion of a construction surface, comprising:
(i) providing a laminate according to claim 1;
(ii) applying a portion of the laminate onto the construction surface, wherein the BCS is located proximate to the construction surface and the BNL is located distal to the construction surface; and
(iii) adhering the BCS to the construction surface.

20. The method of claim 19, wherein the laminate is provided in the form of a roll having a first end and a second end, and wherein the first end of the roll is adhered to the construction surface, and the roll is unwound and adhered to the construction surface.
